(19) United States
(12) Patent Application Publication
(10) Pub. No.: US 2018/0039641 A1
(43) Pub. Date: Feb. 8, 2018

(54) METHOD AND SYSTEM FOR INFORMATION RETRIEVAL FOR A SPATIAL REGION

(71) Applicant: XEROX CORPORATION, Norwalk, CT (US)

(72) Inventors: Anirban Mondal, Greater Noida (IN); Tridib Mukherjee, Bangalore (IN); Atul Singh, Bangalore (IN); Deepthi Chander, Cochin (IN)

(21) Appl. No.: 15/225,919

(22) Filed: Aug. 2, 2016

(51) Int. Cl. G06F 17/30

(52) U.S. Cl. CPC G06F 17/3087; G06F 17/30241; G06F 17/3053

(57) ABSTRACT

The disclosed embodiments illustrate method and system for information retrieval for a spatial region. The method includes receiving a query that comprises a first entity selection criteria, a second entity selection criteria, and a count of entities. The method further includes identifying a node, from a set of nodes at a level of a hierarchal database, having a bounding box, which satisfies the first entity selection criteria, wherein the node comprises at least a first array, wherein the first array comprises one or more second pointer values. The method further includes identifying a second pointer value from the one or more second pointer values that satisfies the second entity selection criteria, wherein the identified second pointer value is associated with a second array. Further, the method includes retrieving a subset of entities from a set of entities in the second array based on the count of entities in the query.

### TECHNICAL FIELD

The presently disclosed embodiments are related, in general, to information processing and information retrieval. More particularly, the presently disclosed embodiments are related to methods and systems for information processing and information retrieval for a spatial region.

### BACKGROUND

Recent advancements in the field of cloud-computing have led to the adoption of crowd-sensing as one of the popular modes to collect context-aware event information, such as information related to traffic congestion, accidents, potholes, and the like. Users (such as residents) can report such context-aware event information to key stakeholders (such as city governments, town planning departments, or law enforcement departments), via apps installed on their mobile devices, such as smartphones. Based on the reported context-aware event information, event distribution, and the level of involvement of the users in such event reporting, the key stakeholders can suitably incentivize such users. For example, a city transportation department (one of the key stakeholders) may identify and offer recognition and rewards, such as discounts in parking and tolling fees, to the top active users for a given region to ensure their continued long-term involvement in the event reporting. On the contrary, the users may also be indicated the breakdown of their involvement across different events and regions, thereby encouraging them to contribute more towards reporting certain events in various regions, specifically where the user involvement has been relatively low.

With ever-increasing number of users reporting the event information, storage and retrieval of the event information in various relational and hierarchal databases has become more challenging. Generally, the time required to extract information from the existing database structures depends on the amount of information to be extracted. Further, as the number of events increases, the retrieval of event information pertaining to users associated with events across different spatial granularities, becomes more time consuming. Thus, there is required an advance mechanism for efficient and scalable storage and the retrieval of user involvement and the event information across different spatial regions as well as at different spatial granularities.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method of information retrieval for a spatial region. The method includes receiving, by one or more transceivers in an electronic device, a query that comprises a first entity selection criteria, a second entity selection criteria, and a count of entities. The method further includes identifying, by one or more processors in the electronic device, a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values. The method further includes identifying, by the one or more processors in the electronic device, a second pointer value from the one or more second pointer values that satisfies the second entity selection criteria, wherein the identified second pointer value is associated with a second array that comprises a set of entities. The method further includes retrieving, by the one or more processors in the electronic device, a subset of entities from the set of entities based on the count of entities in the received query, wherein a response time of the query is independent of the count of entities in the subset of entities retrieved from the hierarchal database.

According to embodiments illustrated herein, there is provided a method of information processing. The method includes receiving, by one or more transceivers in an electronic device, information from another electronic device associated with a user, wherein the information comprises a first parameter, a second parameter, and a first score associated with the user. The method further includes processing, by one or more processors in the electronic device, the received information. The processing of the received information comprises identifying, by the one or more processors in the electronic device, a node, from a set of nodes at a level of a hierarchal database, having a bounding box that is associated with the first parameter, wherein the identified node comprises a set of first pointer values and a first array, wherein the first array comprises one or more second pointer values. The processing of the received information further comprises identifying, by the one or more processors in the electronic device, a second pointer value from the one or more second pointer values that is associated with the second parameter, wherein the identified second pointer value is associated with a second array that comprises a set of entities, wherein each entity in the set of entities has a second score. The processing of the received information further comprises storing, by the one or more processors in the electronic device, the received information as an indexed entity in the second array, if the first score of the information is greater than or equal to the second score of each entity in the set of entities.

According to embodiments illustrated herein, there is provided a system for information retrieval for a spatial region. The system includes one or more processors in an electronic device configured to receive a query that comprises a first entity selection criteria, a second entity selection criteria, and a count of entities. The one or more processors in the electronic device are further configured to identify a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values. The one or more processors in the electronic device are further configured to identify a second pointer value from the one or more second pointer values that satisfies the second entity selection criteria, wherein the identified second pointer value is associated with a second array that comprises a set of entities. The one or more processors in the electronic device are further configured to retrieve a subset of entities from the set of entities based on the count of entities in the received query, wherein a response time of the query is independent of the count of entities in the subset of entities retrieved from the hierarchal database.

According to embodiments illustrated herein, there is provided a system for information processing. The system includes one or more processors in an electronic device configured to receive information, by utilizing one or more transceivers in the electronic device, from another electronic device associated with a user, wherein the information comprises a first parameter, a second parameter, and a first score associated with the user. The one or more processors in the electronic device are further configured process the received information. For processing the received information, the one or more processors in the electronic device are further configured to identify a node, from a set of nodes at a level of a hierarchal database, having a bounding box that is associated with the first parameter, wherein the identified node comprises a set of first pointer values and a first array, wherein the first array comprises one or more second pointer values. For processing the received information, the one or more processors in the electronic device are further configured to identify a second pointer value from the one or more second pointer values that is associated with the second parameter, wherein the identified second pointer value is associated with a second array that comprises a set of entities, wherein each entity in the set of entities has a second score. For processing the received information, the one or more processors in the electronic device are further configured to store the received information as an indexed entity in the second array, if the first score of the information is greater than or equal to the second score of each entity in the set of entities.

According to embodiments illustrated herein, there is provided a computer program product for use with a computing device. The computer program product comprises a non-transitory computer readable medium storing a computer program code for information retrieval for a spatial region. The computer program code is executable by one or more processors to receive a query, by utilizing one or more transceivers. The query comprises a first entity selection criteria, a second entity selection criteria, and a count of entities. The computer program code is further executable by the one or more processors to identify a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values. The computer program code is further executable by the one or more processors to identify a second pointer value from the one or more second pointer values that satisfies the second entity selection criteria, wherein the identified second pointer value is associated with a second array that comprises a set of entities. The computer program code is further executable by the one or more processors to retrieve a subset of entities from the set of entities based on the count of entities in the received query, wherein a response time of the query is independent of the count of entities in the subset of entities retrieved from the hierarchal database.

According to embodiments illustrated herein, there is provided a computer program product for use with a computing device. The computer program product comprises a non-transitory computer readable medium storing a computer program code for information processing. The computer program code is executable by one or more processors to receive information, by utilizing one or more transceivers, from another electronic device associated with a user, wherein the information comprises a first parameter, a second parameter, and a first score associated with the user. The computer program code is further executable by the one or more processors to process the received information. For processing the received information, the computer program code is further executable by the one or more processors to identify a node, from a set of nodes at a level of a hierarchal database, having a bounding box that is associated with the first parameter, wherein the identified node comprises a set of first pointer values and a first array, wherein the first array comprises one or more second pointer values. For processing the received information, the computer program code is further executable by the one or more processors to identify a second pointer value from the one or more second pointer values that is associated with the second parameter, wherein the identified second pointer value is associated with a second array that comprises a set of entities, wherein each entity in the set of entities has a second score. For processing the received information, the computer program code is further executable by the one or more processors to store the received information as an indexed entity in the second array, if the first score of the information is greater than or equal to the second score of each entity in the set of entities.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates an application server, in accordance with at least one embodiment;

FIG. 3A is a block diagram that illustrates a structure of a hierarchal database, in accordance with at least one embodiment;

FIG. 3B is a block diagram that illustrates a structure of an updated hierarchal database, in accordance with at least one embodiment;

FIGS. 4A and 4B are flowcharts that collectively illustrate a method for information processing, in accordance with at least one embodiment;

FIG. 5 is a flowchart that illustrates a method for information retrieval for a spatial region, in accordance with at least one embodiment;

FIG. 6 illustrates an exemplary Graphical User Interface (GUI) presented to a user on an exemplary user-computing device for providing the information, in accordance with at least one embodiment;

FIG. 7A illustrates a first exemplary Graphical User Interface (GUI) presented to a service provider on an exemplary agent-computing device for providing a query, in accordance with at least one embodiment;

FIG. 7B illustrates a second exemplary Graphical User Interface (GUI) presented to a service provider on an exemplary agent-computing device for providing a query, in accordance with at least one embodiment; and

FIG. 8 illustrates an exemplary Graphical User Interface (GUI) presented to a service provider on an exemplary agent-computing device for displaying a result of a query, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

An “electronic device” refers to a device that includes one or more processors/microcontrollers and/or any other electronic component, a device, or a system that performs one or more operations according to one or more programming instructions/codes. In an embodiment, the electronic device may correspond to a computing device. Examples of the electronic device may include, but are not limited to, a desktop computer, a laptop, a personal digital assistant (PDA), a mobile device, a smartphone, and a tablet computer (e.g., iPad® and Samsung Galaxy Tab®).

“Information” refers to data transmitted by one or more users on an online information portal (e.g., a crowd-sensing platform) over the World Wide Web. In an embodiment, the information may correspond to an event report. In an embodiment, the information may correspond to a comment, a post, a share, or a tweet. In an embodiment, the information may comprise a first parameter and a second parameter. For example, a user “U₁” may transmit information “Traffic Jam at National Highway—8, at 3:00 PM” that corresponds to a traffic congestion event.

A “spatial region” refers to a geographical region defined by a specific boundary. In an embodiment, the spatial region may comprise one or more geographical locations. Examples of the spatial region may include one or more localities, one or more towns, one or more cities, one or more states, one or more countries, and/or the like.

A “query” refers to a question statement provided by another user, such as a stakeholder. In an embodiment, the other user may submit the query by utilizing an electronic device for retrieving information. In an embodiment, the query may comprise a first entity selection criteria, a second entity selection criteria and a count of entities. The information (i.e., the count of entities) that satisfies the first entity selection criteria and the second entity selection criteria is retrieved from a database. In an embodiment, the other user may submit the query for the information retrieval associated with a spatial region. In an embodiment, the other user may utilize one or more querying languages, such as, but are not limited to, SQL, QUEL, and DMX. In another embodiment, the other user may submit a query in natural language. For example, “Top two users in Madison Avenue that reported a fire accident.”

“First entity selection criteria” refers to a first condition, in a query, to retrieve indexed information from a database. In an embodiment, the information that satisfies the first entity selection criteria may be retrieved from the database. In an embodiment, the first entity selection criteria may be associated with a geographical location in a spatial region. For example, in a query “Top two users in Madison Avenue that reported a fire accident,” “Madison Avenue” may correspond to the first entity selection criteria.

“Second entity selection criteria” refers to a second condition, in a query, to retrieve indexed information from a database. In an embodiment, the information that satisfies the second entity selection criteria may be retrieved from the database. In an embodiment, the second entity selection criteria may be associated with an event that occurred at a geographical location in a spatial region. The geographical location may be associated with a first entity selection criteria in the query. For example, in a query “Top two users in Madison Avenue that reported a fire accident,” “fire accident” may correspond to the second entity selection criteria.

A “count of entities” refers to a number of entities/items that are to be retrieved from a database, based on a query. In an embodiment, the count of entities retrieved from the database satisfies first entity selection criteria and second entity selection criteria in the query. For example, in a query “Top two users in Madison Avenue that reported about a fire accident,” “two” may correspond to the count of entities retrieved from the database.

A “hierarchal database” refers to a database structure that comprises a plurality of levels arranged in a tree-like manner. In an embodiment, a set of nodes may be arranged in the hierarchal database at each of the plurality of levels.

A “node” at a level in a hierarchal database comprises a set of first pointer values, a bounding box, and a first array. In an embodiment, the node at the hierarchal level may be associated with a geographical location in a spatial region. In an embodiment, the bounding box of the node may be utilized to identify the geographical location associated with the node.

A “bounding box” represents a general position of a geographical location in a spatial region. In an embodiment, the bounding box is utilized for indexing spatial information. In an embodiment, the bounding box may correspond to geographical coordinates of the geographical location in the spatial region. The bounding box of a parent node in a hierarchal database encompasses the bounding boxes of all corresponding child nodes. For example, in a hierarchal database node “A” is a parent node, and “B” and “C” are child nodes. The bounding box of the parent node “A” may correspond to a super-set of geographical coordinates (such as “(a, b, c, d)”) The bounding box of node “B” may correspond to a first sub-set of geographical coordinates (such as “(a₁, b₁, c₁, d₁)”) and node “C” may correspond to a second sub-set of geographical coordinates (such as “(a₂, b₂, c₂, d₂)”). In this scenario, the spatial region that corresponds to the super-set of geographical coordinates “(a, b, c, d)” encompasses the spatial regions that correspond to the first sub-set of geographical coordinates “(a₁, b₁, c₁, d₁)” and the second sub-set of geographical coordinates “(a₂, b₂, c₂, d₂).”

A “set of first pointer values” represents a set of child nodes of a parent node in a hierarchal database. In an embodiment, if the node corresponds to a leaf node, the set of first pointer values may point to a memory location where information associated with a bounding box of the leaf node is stored.

A “first array” of a node in a hierarchal database refers to a hash-based array. In an embodiment, each element of the first array may be associated with an event that has a unique event identifier. Further, each event in the first array may correspond to a second pointer value.

“One or more second pointer values” in a first array of a node in a hierarchal database are associated with one or more events. Each of the one or more second pointer values is associated with a unique event identifier. In an embodiment, each second pointer value may be associated with a second array in the hierarchal database.

A “second array” in a hierarchal database comprises a set of entities with a fixed-length array structure. In an embodiment, a second array may be associated with a second pointer value in a first array of a node in the hierarchal database.

A “set of entities” refers to indexed information that is stored in a hierarchal database. In an embodiment, a second array comprises the set of entities. In an embodiment, an entity may comprise a user identification and a second score associated with a user. The user identification in the entity is associated with the user that transmitted the information pertaining to the entity. In another embodiment, the entity may further comprise a pointer value that is associated with a memory location that stores a user profile of the corresponding user.

“Response time” refers to a total amount of time required to respond to a query. In an embodiment, the response time may refer to the amount of time elapsed between a time instant of submission of the query and a time instant of reception of the query result.

A “geographical location” refers to a geographical area, such as a region, a country, a state, a county, a city, a town, a village, a district, or a locality.

An “event” refers to an activity that occurs at a geographical location and involves one or more users. Examples of various types of events include, but are not limited to, a seasonal event, a public event, a business event, or a sports event.

A “first score” refers to a score associated with a user that transmits information. In an embodiment, the first score may be determined based on a count of times the user transmits information or an accuracy level of information transmitted by the user. In an embodiment, the first score may be determined based on an importance level associated with information transmitted by the user.

A “first parameter” refers to first data in information transmitted by a user. In an embodiment, the first parameter may be associated with a geographical location. For example, a user reports about an event “e₁” that occurred at a geographical location “G₁.” In this scenario, the geographical location “G₁” in the user report may correspond to the first parameter.

A “second parameter” refers to second data in information transmitted by a user. In an embodiment, the second parameter may be associated with an event that occurred a geographical location. For example, a user reports about an event “e₁” that occurred at a geographical location “G₁.” In this scenario, the event “e₁” that occurred the geographical location “G₁” in the user report may correspond to the second parameter.

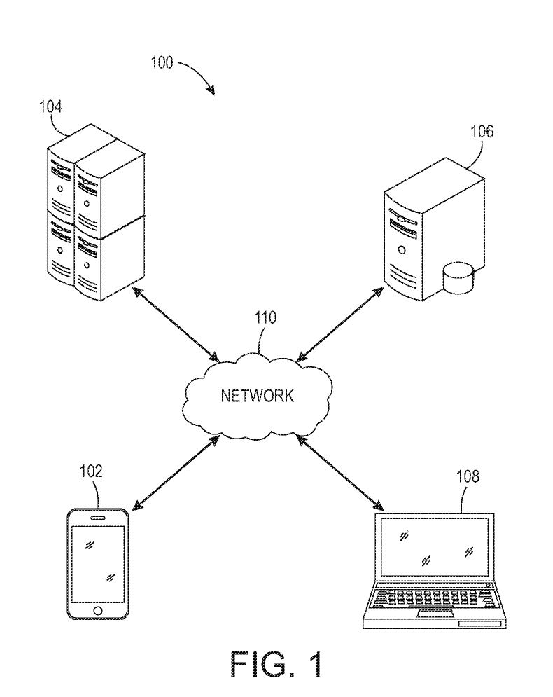

FIG. 1 is a block diagram of a system environment in which various embodiments may be implemented. With reference to FIG. 1, there is shown a system environment 100 that includes a user-computing device 102, an application server 104, a database server 106, an agent-computing device 108, and a network 110. Various devices in the system environment 100 may be interconnected over the network 110. FIG. 1 shows, for simplicity, one user-computing device 102, one application server 104, one database server 106, and one agent-computing devices 108. However, it will be apparent to a person having ordinary skill in the art that the disclosed embodiments may also be implemented using multiple user-computing devices, multiple application servers, multiple databases, and multiple agent-computing devices, without departing from the scope of the disclosure.

In an embodiment, the user-computing device 102, associated with a user, may refer to an electronic device or a computing device communicatively coupled to the network 110. The user-computing device 102 may include one or more processors and one or more memories. The one or more memories may include computer readable codes and instructions that may be executable by the one or more processors to perform predetermined operations specified by the user. The predetermined operations may include transmitting information to the application server 104. The transmitted information may comprise a first parameter and a second parameter. In an embodiment, the first parameter may be associated with a geographical location and the second parameter may be associated with an event that occurred at the geographical location. In an embodiment, the geographical location may be a part of a spatial region.

In an embodiment, the user-computing device 102 may include a navigation device with inbuilt Global Positioning System (GPS) sensors. In an embodiment, the GPS sensors in the user-computing device 102 may be configured to determine a current geographical location of the user. Further, the user-computing device 102 may be configured to transmit the current geographical location of the user to the application server 104, when the information is transmitted. Prior to the transmission of the information, the user may utilize the user-computing device 102 for registering on an online information portal associated with the application server 104. In an embodiment, the online information portal may correspond to a crowd-sensing platform.

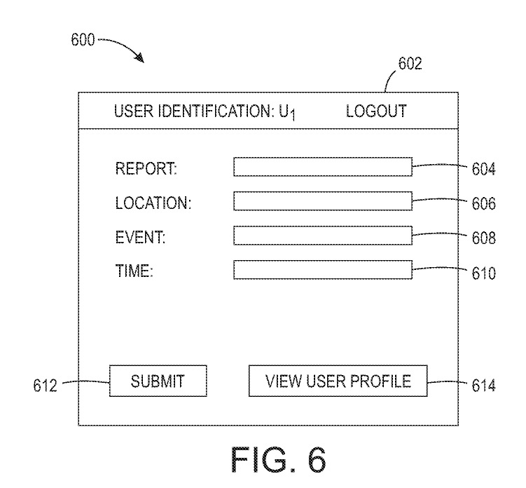

In an embodiment, the user-computing device 102 may present a Graphical User Interface (GUI), received from the application server 104, to the user. The user may utilize the GUI presented on the user-computing device 102 for providing the information to be transmitted to the application server 104. An exemplary GUI presented on the user-computing device 102 for providing the information has been described later in FIG. 6.

The user-computing device 102 may correspond to a variety of computing devices such as, but not limited to, a laptop, a PDA, a tablet computer, a smartphone, and a phablet.

A person having ordinary skill in the art will understand that the scope of the disclosure is not limited to the utilization of the user-computing device 102 by a single user. In an embodiment, the user-computing device 102 may be utilized by more than one users to transmit the information.

In an embodiment, the application server 104 may refer to an electronic device, a computing device, or a software framework hosting an application or a software service that may be communicatively coupled to the network 110. In an embodiment, the application server 104 may be implemented to execute programs, routines, scripts, and/or the like, stored in one or more memories for supporting the hosted application or the software service. In an embodiment, the hosted application or the software service may be configured to perform one or more predetermined operations. In an embodiment, the one or more predetermined operations may include processing the received information and retrieving the information based on a query.

In an embodiment, the application server 104 may be configured to transmit the GUI to the user-computing device 102 associated with the user. The user may utilize the GUI for presenting the information for the user. The application server 104 may receive the information from the user-computing device 102 associated with the user. In an embodiment, the application server 104 may be configured to determine a first score for the user associated with the received information. In an embodiment, the application server 104 may be configured to update an activity record of the user, based on the received information.

In an embodiment, the application server 104 may be configured to process the information to generate indexed information. The application server 104 may be configured to store the indexed information in a hierarchal database that comprises a plurality of levels. Further, each level in the plurality of levels may comprise one or more nodes.

In an embodiment, a node in the one or more nodes may correspond to a leaf node. The leaf node may comprise a set of first pointer values, a bounding box, and a first array. The set of first pointer values of the leaf node comprises a first pointer value. The first pointer value in the set of first pointer values of the leaf node may be associated with a geographical location in the spatial region. For example, a first pointer value “ptr₁” in the set of first pointer values of a leaf node may point to a memory location of the database server 106, where details pertaining to a geographical location (e.g., “G₁”) in a spatial region (e.g., “S”) are stored. The details may further comprise coordinates associated with the geographical location. Further, the bounding box of the leaf node may be associated with the geographical location pointed to by the first pointer value in the set of first pointer values of the leaf node. For example, a bounding box “BR” of a leaf node may correspond to geographical coordinates (i.e., (a₁, b₁, c₁, d₁)) of the geographical location “G₁” in the spatial region “S.” Further, the first array of the leaf node may comprise one or more second pointer values, such that a second pointer value in the one or more second pointer values is associated with an event. In an embodiment, each event has a unique event identifier. For example, a second pointer value “e₁” may be associated with an event that occurred at the geographical location “G₁.” A second pointer value of the one or more second pointer values is associated with a second array that comprises a set of entities. In an embodiment, the second pointer value may point to a memory location in the database server 106, where the second array is stored. For example, the second pointer value “e₁” in the first array of the leaf node may be associated with a second array that comprises indexed information (i.e., the set of entities) transmitted by one or more users pertaining to the event that occurred at the geographical location “G₁” in the spatial region “S.”

In an alternate embodiment, a node in the one or more nodes may correspond to a non-leaf node. The non-leaf node may also comprise the set of first pointer values, the bounding box, and the first array. A first pointer value in the set of first pointer values of the non-leaf node may be associated with a child node of the non-leaf node. Further, the bounding box of the non-leaf node may be associated with a geographical location. For example, a bounding box “BR” of a non-leaf node may correspond to geographical coordinates (i.e., (a₂, b₂, c₂, d₂)) of the geographical location “G₂” in the spatial region “S.” The geographical location “G₂” of the non-leaf node may encompass the geographical locations of all child nodes of the non-leaf node. Further, the first array of the non-leaf node may comprise the one or more second pointer values, such that a second pointer value in the one or more second pointer values is associated with an event. In an embodiment, the event has a unique identifier. For example, a second pointer value may be associated with an event that occurred at the geographical location “G₂.” The second pointer value is further associated with a second array, that comprises a set of entities. In an embodiment, the second pointer value may point to a memory location in the database server 106, where the second array is stored. For example, a second pointer value “e₁” in the first array of the non-leaf node may be associated with a second array that comprises indexed information (i.e., the set of entities) transmitted by one or more users pertaining to the event that occurred at the geographical location “G₂” in the spatial region “S.”

The application server 104 may be configured to store the indexed information as an entity in the hierarchal structure. For storing the indexed information, the application server 104 may identify a node from the set of nodes at a level in the plurality of levels having the bounding box that is associated with the first parameter. For the identification of the node, the application server 104 may be configured compare the geographical location associated with the first criteria of the information and the geographical location associated with the bounding box of each node in the one or more nodes. Further, the application server 104 may identify a second pointer value from the one or more second pointer values in the first array of the identified node. For the identification of the second pointer value, the application server 104 may compare the event associated with the second parameter of the information with the event associated with each second pointer value in the first array of the identified node. Thereafter, the application server 104 may store the information in the second array, if the first score of the information (i.e., the first score associated with the user, who has transmitted the information) is greater than or equal to a second score of at least one entity in the set of entities of the identified second array.

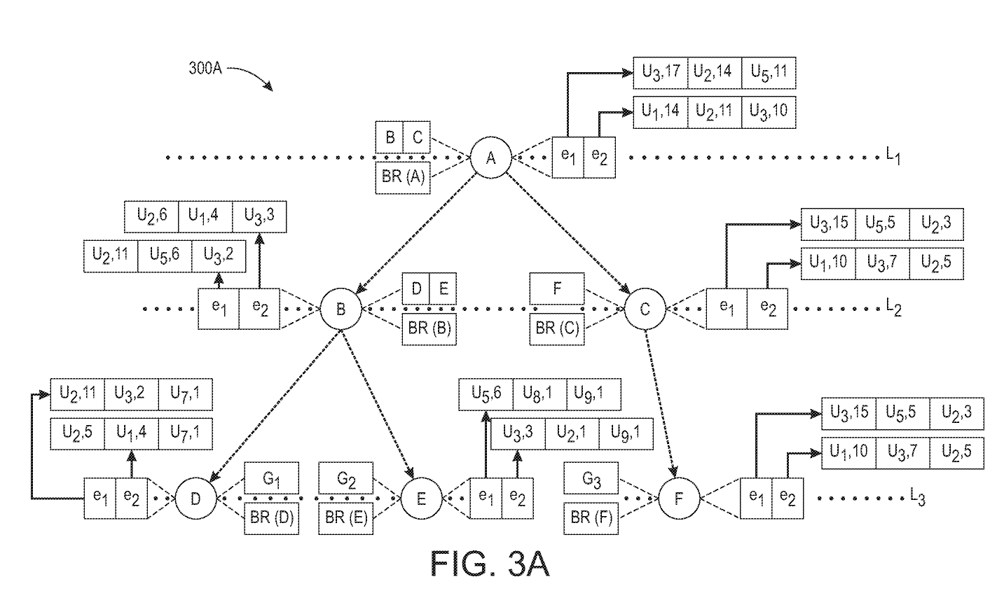

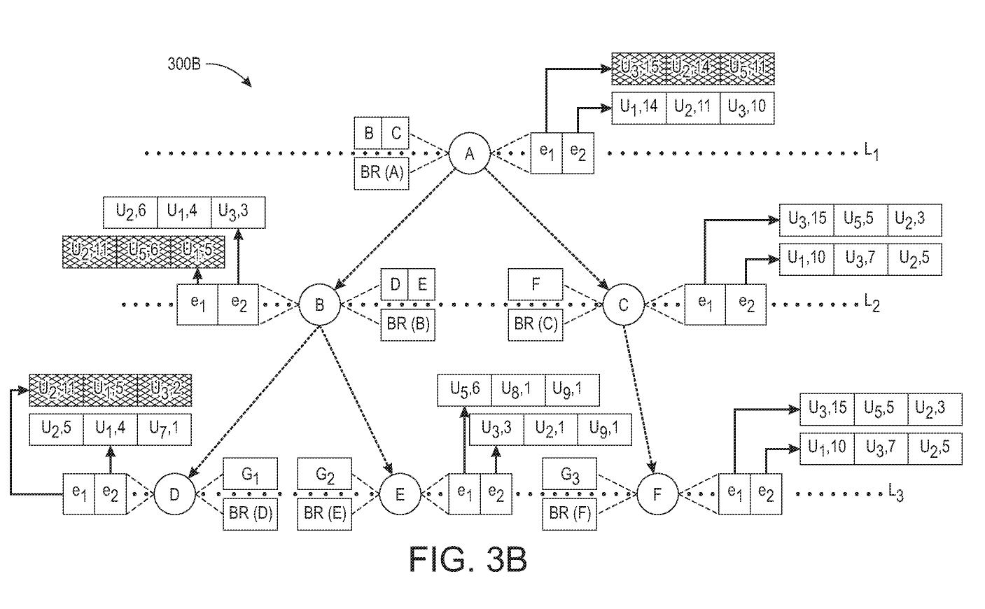

In an embodiment, the application server 104 may utilize the processed information for updating an event record and a geographical location record stored in the database server 106. The detailed structure of the hierarchal database has been described later in FIGS. 3A and 3B.

In an embodiment, the application server 104 may be configured to receive a query from the agent-computing device 108. The received query may comprise first entity selection criteria, second entity selection criteria, and a count of entities. In an embodiment, the first entity selection criteria in the query may correspond to a geographical location in the spatial region. The second entity selection criteria may correspond to an event that occurred at the geographical location in the spatial region. In an embodiment, the application server 104 may be configured to extract a result of the query by traversing the hierarchal database. The application server 104 may utilize the first entity selection criteria and the second entity selection criteria for extracting the query result. For the extraction of the query result, the application server 104 may be configured to identify a node at a level in the hierarchal database whose bounding box satisfies the first entity selection criteria. Further, the application server 104 may identify a second pointer value in the first array of the identified node that satisfies the second entity selection criteria. Thereafter, the application server 104 may be configured to retrieve a subset of entities from a set of entities in a second array associated with the identified second pointer value. The application server 104 may retrieve the subset of entities based on the count of entities in the received query. In an embodiment, the application server 104 may be configured to transmit the retrieved subset of entities to the agent-computing device 108.

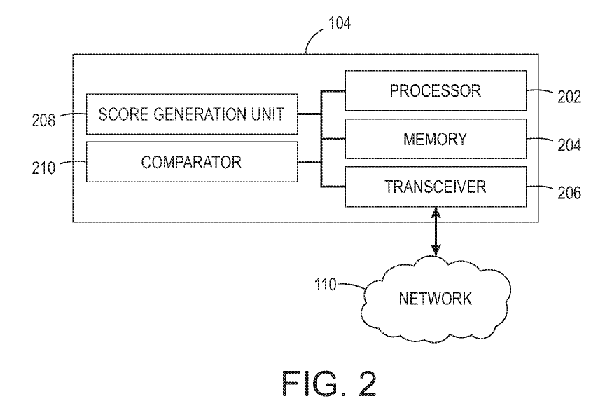

The application server 104 may be realized through various types of application servers, such as, but not limited to, a Java application server, a .NET framework application server, a Base4 application server, a PHP framework application server, or any other application server framework. The operation of the application server 104 has been discussed later in FIG. 2.

In an embodiment, the database server 106 may refer to a computing device that may be communicatively coupled to the network 110. In an embodiment, the database server 106 may be configured to store a user profile of the user, created during the registration of the user. The user profile of the user may comprise information pertaining to the user, such as an identification of the user, information transmitted by the user, and the first score associated with the user.

In an embodiment, the database server 106 may be further configured to store the geographical location record, the event record, and the user activity record. The geographical location record may comprise information pertaining to one or more geographical locations in the spatial region, such as the coordinates of the one or more geographical locations. In an embodiment, the geographical location record may comprise a geographical map pertaining to the one or more geographical locations in the spatial region. Further, the event record may comprise information pertaining to one or more events, such as the unique event identifier associated with each of the one or more events. In an embodiment, the activity record associated with the user may comprise the information transmitted by the user, the first score determined for the user, and a time instant associated with the transmission of the information. In an embodiment, the database server 106 may be further configured to store the hierarchal database comprising the indexed information.

Further, in an embodiment, the database server 106 may be configured to transmit/receive one or more instructions/queries/information to/from one or more devices (i.e., the user-computing device 102, the application server 104, and the agent-computing device 108) over the network 110. In an embodiment, the database server 106 may receive the query from the application server 104 to retrieve information from the hierarchal database, the activity record of the user, the geographical location record, and the event record. For querying the database server 106, one or more querying languages may be utilized, such as, but not limited to, SQL, QUEL, and DMX. Further, the database server 106 may be realized through various technologies such as, but not limited to, Microsoft® SQL server, Oracle, and My SQL.

A person having ordinary skill in the art will appreciate that the scope of the disclosure is not limited to realizing the application server 104 and the database server 106 as separate entities. In an embodiment, the functionalities of the application server 104 can be integrated into the database server 106.

The agent-computing device 108 refers to an electronic device or a computing device that includes one or more processors and one or more memories. The one or more memories may include computer readable codes and instructions that may be executable by the one or more processors to perform predetermined operations. The predetermined operations may include the transmission of the query to the application server 104. The transmitted query may comprise the first entity selection criteria, the second entity selection criteria, and the count of entities. In an embodiment, the first entity selection criteria may correspond to a geographical location in the spatial region. In an embodiment, the second entity selection criteria may correspond to an event that is associated with the first entity selection criteria (i.e., the event occurred at the geographical location). For example, a service provider transmits a query to the application server 104 for retrieving details of five users, who transmitted information pertaining to a fire accident at a location “A.” In this scenario, the location “A” may correspond to the first entity selection criteria, the “fire accident” may correspond to the second entity selection criteria and “five” may correspond to the count of entities.

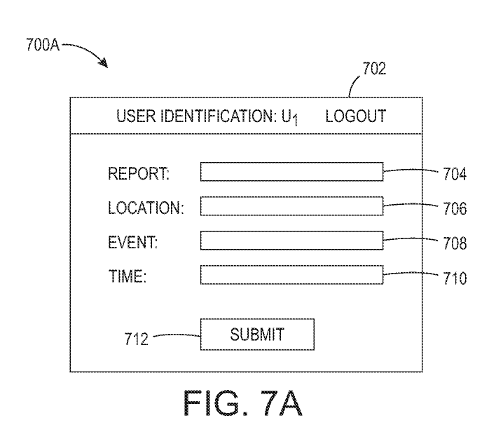

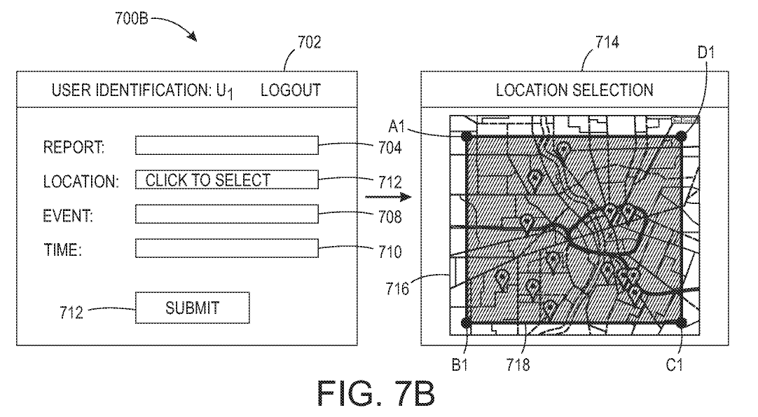

In an embodiment, the agent-computing device 108 may receive the subset of entities from the application server 104. The agent-computing device 108 may be configured to present the subset of entities as a display item to the service provider on a GUI rendered on the agent-computing device 108. The GUI for presenting the display item to the service provider has been discussed later in FIGS. 7A and 7B.

The agent-computing device 108 may correspond to a variety of computing devices such as a laptop, a PDA, a tablet computer, a smartphone, a phablet, and/or the like.

The network 110 corresponds to a medium through which content and messages flow between various devices of the system environment 100 (e.g., the user-computing device 102, the application server 104, the database server 106, and the agent-computing device 108). Examples of the network 110 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 110 in accordance with various wired and wireless communication protocols such as Transmission Control Protocol and Internet Protocol (TCP/IP), User Datagram Protocol (UDP), and 2G, 3G, or 4G communication protocols.

FIG. 2 is a block diagram that illustrates an application server, in accordance with at least one embodiment. FIG. 2 has been described in conjunction with FIG. 1. With reference to FIG. 2, the application server 104 may include a processor 202, a memory 204, a transceiver 206, a score generation unit 208, and a comparator 210.

The processor 202 includes suitable logic, circuitry, and/or interfaces that are configured to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform one or more operations for information processing and information retrieval for the spatial region. In an embodiment, the processor 202 may be configured to parse the information received from the user for identifying the first criteria (e.g., the geographical location) and the second parameter (e.g., the event that occurred at the geographical location). The processor 202 may be further configured to parse the query to identify the first entity selection criteria, the second entity selection criteria, and the count of entities, as specified in the query.

The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store the one or more sets of instructions that are executable by the processor 202, the transceiver 206, the score generation unit 208, and the comparator 210. In an embodiment, the memory 204 may include one or more buffers (not shown). Some of the commonly known memory implementations include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations. It will be apparent to a person having ordinary skill in the art that the one or more instructions stored in the memory 204 may enable the hardware of the application server 104 to perform the predetermined operations, without deviating from the scope of the disclosure.

The transceiver 206 transmits/receives messages and data to/from various components of the system environment 100, such as the user-computing device 102, the database server 106 and the agent-computing device 108, over the network 110. In an embodiment, the transceiver 206 may be communicatively coupled to the network 110. In an embodiment, the transceiver 206 may be configured to receive the information from the user and the query from the service provider. Further, the transceiver 206 may be configured to query the database server 106 to extract information from the hierarchal database, the event record, the geographical location record, and the activity record from the database server 106. Examples of the transceiver 206 may include, but are not limited to, an antenna, an Ethernet port, a universal serial bus (USB) port, or any other port that can be configured to receive and transmit data. The transceiver 206 receives/transmits the demands/content/information/notifications, in accordance with various communication protocols, such as, TCP/IP, UDP, and 2G, 3G, or 4G communication protocols, known in the art.

The score generation unit 208 comprise suitable logic, circuitry, interfaces and/or code that may be configured to execute the one or more instructions stored in the memory 204 to determine the first score for the user who has transmitted the information and a second score associated with each entity in the set of entities in the hierarchal database. The score generation unit 208 may be implemented using one or more processor technologies known in the art. Examples of the score generation unit 208 may include, but are not limited to, an X86, a RISC processor, a CISC processor, or any other processor. In another embodiment, the score generation unit 208 may be implemented as an ASIC microchip designed for a special application such as determining the first score and the second score.

The comparator 210 comprise suitable logic, circuitry, interfaces and/or code that may be configured to execute the one or more instructions stored in the memory 204 to compare the first score associated with the user, who has transmitted the information and the second score associated with each entity in the set of entities. Further, the comparator 210 may be configured to compare the geographical location of the first criteria (i.e., geographical location associated with a node) with the geographical location of the first entity selection criteria and the event associated second parameter (i.e., event associated with a second pointer value) with the second entity selection criteria for information retrieval from the hierarchal database.

In an embodiment, the comparator 210 may be realized through either software technologies or hardware technologies, known in the art. Though, the comparator 210 is depicted as independent from the processor 202 in FIG. 2, a person skilled in the art will appreciate that the comparator 210 may be implemented within the processor 202, without departing from the scope of the disclosure.

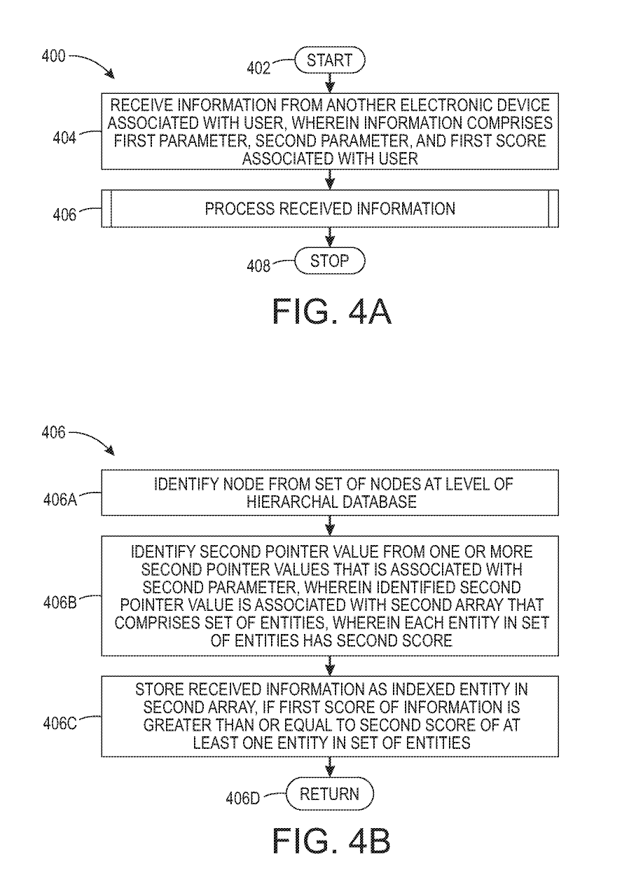

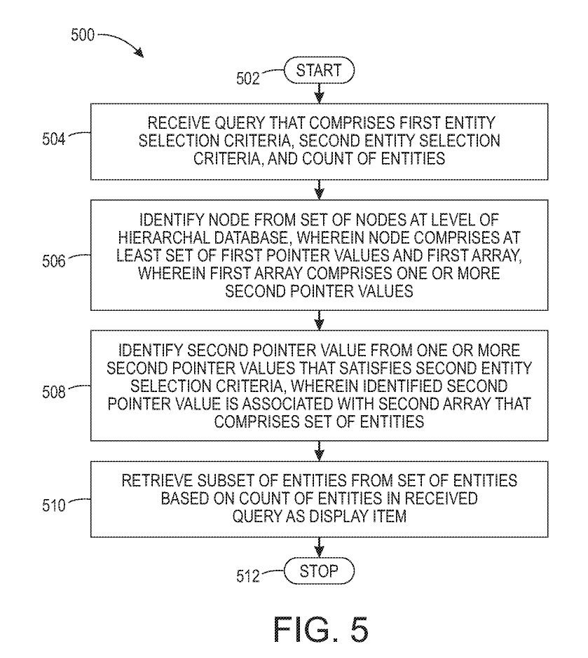

The working of the application server 104 for information processing and information retrieval has been explained later in FIGS. 4A and 4B, and FIG. 5, respectively.

FIG. 3A is a block diagram that illustrates the structure of a hierarchal database, in accordance with at least one embodiment. FIG. 3A is described in conjunction with FIG. 1 and FIG. 2. With reference to FIG. 3A, there is shown a block diagram that illustrates the structure of a hierarchal database 300a. A person with ordinary skills in the art will understand that for brevity, the plurality of levels in the hierarchal database 300a include three levels only. Notwithstanding, the disclosure may not be so limited, and the plurality of levels in the hierarchal database 300a may include more than three levels, without deviating from the scope of the disclosure.

The hierarchal database 300a comprises the plurality of levels, such as a first level “L₁,” a second level “L₂,” and a third level “L₃.” The first level “L₁” comprises a set of nodes that includes node “A.” The second level “L₂” comprises a set of nodes that includes nodes “B” and “C.” The third level “L₃” comprises a set of nodes that includes nodes “D,” “E,” and “F.” As apparent to a person ordinary skilled in the art, each node at a lower level corresponds to a child node of a node at an upper level. For example, nodes “B” and “C” at the second level “L₂” correspond to child nodes of the node “A” at the first level “L₁” of the hierarchal database 300a. Further, nodes “B” and “C” are the child nodes of the node “A,” nodes “D,” and “E” are the child nodes of the node “B,” and node “F” is the child node of the node “C.” Each of the nodes “A,” “B,” and “C” corresponds to non-leaf nodes and each of the nodes “D,” “E,” and “F” corresponds to leaf nodes.

Each node (i.e., “A,” “B,” “C,” “D,” “E,” and “F”) of the hierarchal database 300a comprises the set of first pointer values, the bounding box and the first array. Table 1 depicts the set of first pointer values, the bounding box and the first array associated with each of the nodes “A,” “B,” “C,” “D,” “E,” and “F” in the hierarchal database 300a.

TABLE 1
Illustrates the set of first pointer values, the bounding box and the first
array associated with each of the nodes “A”, “B”, “C”, “D”, “E”, and “F”.

| | Set of first pointer | | |
|---|---|---|---|
| Node | values | Bounding box | First array |
| A | [B, C] | BR(A) -> (a₆, b₆, c₆, d₆) | [e₁, e₂] |
| B | [D, E] | BR(B) -> (a₄, b₄, c₄, d₄) | [e₁, e₂] |
| C | [F] | BR(C) -> (a₅, b₅, c₅, d₅) | [e₁, e₂] |
| D | [ptr₁] | BR(D) -> (a₁, b₁, c₁, d₁) | [e₁, e₂] |
| E | [ptr₂] | BR(E) -> (a₂, b₂, c₂, d₂) | [e₁, e₂] |
| F | [ptr₃] | BR(F) -> (a₃, b₃, c₃, d₃) | [e₁, e₂] |

In an embodiment, the bounding box associated with a node in the hierarchal database 300a corresponds to coordinates of a rectangle (i.e., a geographical location in the spatial region). Further, the bounding box of a non-leaf node encompasses the bounding boxes of all the child nodes associated with the non-leaf node. For example, with reference to Table 1, the bounding box “(a₄, b₄, c₄, d₄),” which is associated with node “B,” encompasses the bounding box “(a₁, b₁, c₁, d₁),” which is associated with the child node “D,” and the bounding box “(a₂, b₂, c₂, d₂),” which is associated with the child node “E.” Similarly, the bounding box “(a₆, b₆, c₆, d₆),” which is associated with node “A,” encompasses the bounding box “(a₄, b₄, c₄, d₄),” which is associated with the child node “B,” and the bounding box “(a₅, b₅, c₆, d₅),” which is associated with the child node “C.”

Further, the first array of each node comprises the one or more second pointer values (e.g., first array of the node “A” comprises two second pointer values, such as “e₁” and “e₂”). In an embodiment, each of the one or more second pointer values may be associated with an event that occurred at a geographical location represented by the bounding box of the corresponding node. For example, the second pointer value “e₁” in the first array of the node “A” may be associated with an event that occurred at a geographical location represented by the bounding box “(a₆, b₆, c₆, d₆).”

Further, a second pointer value in the one or more second pointer values may be associated with a second array that comprises a set of entities. In an embodiment, the second pointer value may point to a memory location in the database server 106, where the corresponding second array is stored. Table 2, illustrates each second array associated with each of the one or more second pointer values in the first array of each node in the hierarchal database 300a.

TABLE 2
Illustrates the second array associated with each of the one or more
second pointer values in the first array of each node in the hierarchal
database 300a.

| | | Second pointer | |
|---|---|---|---|
| Node | First array | values | Second array |
| A | [e₁, e₂] | e₁ | [(U₃, 17), (U₂, 14), (U₅, 11)] |
| | | e₂ | [(U₁, 14), (U₂, 11), (U₃, 10)] |
| B | [e₁, e₂] | e₁ | [(U₂, 11), (U₅, 6), (U₃, 2)] |
| | | e₂ | [(U₂, 6), (U₁, 4), (U₃, 3)] |
| C | [e₁, e₂] | e₁ | [(U₃, 15), (U₅, 5), (U₂, 3)] |
| | | e₂ | [(U₁, 10), (U₃, 7), (U₂, 5)] |
| D | [e₁, e₂] | e₁ | [(U₂, 11), (U₃, 2), (U₇, 1)] |
| | | e₂ | [(U₂, 5), (U₁, 4), (U₇, 1)] |
| E | [e₁, e₂] | e₁ | [(U₅, 6), (U₈, 1), (U₉, 1)] |
| | | e₂ | [(U₃, 3), (U₂, 1), (U₉, 1)] |
| F | [e₁, e₂] | e₁ | [(U₃, 15), (U₅, 5), (U₂, 3)] |
| | | e₂ | [(U₁, 10), (U₃, 7), (U₂, 7)] |

Each second array associated with each of the one or more second pointer values in the first array of each node in the hierarchal database may comprise the set of entities. For example, the second array “[(U₃, 17), (U₂, 14), (U₅, 11)]” associated with “e₁” in the first array of the node “A” comprises the set of entities “(U₃, 17), (U₂, 14), and (U₅, 11).” An entity (e.g., “(U₃, 17)”) may further comprise a user identification (e.g., “U₃” in “(U₃, 17)”) of the user who has transmitted the information and a second score (e.g., “17” in “(U₃, 17)”). In an embodiment, the second score of each entity in the set of entities associated with the leaf nodes (i.e., “D”, “E”, and “F”) is equal to the first score associated with user who has transmitted the information. Further, the second score of each entity in the set of entities associated with the non-leaf nodes (i.e., “A”, “B”, and “C”) is determined based on the second score of the entities having same second pointer value and same user identification in the corresponding child nodes. For example, with reference to Table 2, the second score of the entity “(U₃, 15)” associated with the second pointer value “e₁” of the leaf node “F” is same as the first score “15” of the user “U₃.” In another example, the second score of the entity “(U₂, 6)” associated with the second pointer value “e₂” of the non-leaf node “B” is the sum of the second scores “5” and “1.” Here, the second score “5” corresponds to the entity “(U₂, 5),” which is associated with the same second pointer value “e₂” of the child node “D.” The second score “1” corresponds to the entity “(U₂, 1),” which is associated with the same second pointer value “e₂” of the child node “E.” In another example, the second score of the entity “(U₂, 11)” associated with the second pointer value “e₂” of the non-leaf node “A” is the sum of the second scores “6” and “5.” Here, the second score “6” corresponds to the entity “(U₂, 6),” which is associated with the same second pointer value “e₂” of the child node “B.” The second score “5” corresponds to the entity “(U₂, 5),” which is associated with the same second pointer value “e₂” of the child node “C.”

In an embodiment, the second array associated with a second pointer value in the first array of a node in the hierarchal database 300a may correspond to a fixed-length array. Further, the entities in each of the set of entities are sorted based on the second score associated with each of the entity. For example, the length of each of the second array in the hierarchal database 300a is “3.” The entities in each of the set of entities in the hierarchal database 300a are sorted in a descending order, based on the second score associated with each entity. A person having ordinary skill in the art will understand that the length “3” of each second array in the hierarchal database 300a is merely for exemplary purpose. In another hierarchal database, with data structure similar to the hierarchal database 300a, the length of each second array may be different, without deviating from the scope of the disclosure.

In an embodiment, the processor 202 may be configured to update the hierarchal database 300a for storing the information transmitted by a user as an indexed entity. An updated hierarchal database 300b has been explained (in conjunction with Table 3 described in FIGS. 4A and 4B). With reference to FIG. 3B, there is shown the updated hierarchal database 300b based on the received information from the user. The updated second array in the updated hierarchal database 300b has been depicted as a shaded second array.

The method to store the information has been described later in FIGS. 4A and 4B. Further, the processor 202 may traverse the hierarchal database 300a, depth-wise (from top to bottom), for the retrieval of the subset of entities, based on the received query. The method to retrieve the subset of entities from the hierarchal database 300a or 300b has been described later in FIG. 5.

FIGS. 4A and 4B are flowcharts that collectively illustrate a method for information processing, in accordance with at least one embodiment. FIGS. 4A and 4B is described in conjunction with FIG. 1, FIG. 2, FIG. 3A, and FIG. 3B. With reference to FIG. 4A, there is shown a flowchart 400 that illustrates a method for information processing. With reference to FIG. 4B, there is shown a sub-flowchart for method step 406, as illustrated in the flowchart 400 in FIG. 4A. For the purpose of ongoing description, the method has been explained for information received from one user. However, the scope of the disclosure should not be construed to be limiting to the user. In an embodiment, the following steps can also be performed for information received from more than one users. Further, a person having ordinary skill in the art will understand that the examples, as described in FIGS. 4A and 4B, are for illustrative purpose and should not be construed limiting to the scope of the disclosure. With reference to FIG. 4A, as illustrated in the flowchart 400, the method starts at step 402 and proceeds to step 404.

At step 404, the information is received from another electronic device associated with the user. The information comprises first criteria, a second parameter, and a first score associated with the user. In an embodiment, the transceiver 206, in conjunction with the processor 202, may be configured to receive the information from the user-computing device 102 (i.e., another electronic device) associated with the user. The information received may comprise the first parameter, the second parameter, and the first score associated with the information, provided by the user. In an embodiment, the first parameter may be associated with a geographical location in a spatial region. The second parameter may be associated with an event that occurred at the geographical location. For example, the user may transmit the information comprising a first parameter associated with the geographical location “G₁” in the spatial region “5,” and a second parameter associated with the event that occurred at the geographical location “G₁.” In an embodiment, the score generation unit 208, in conjunction with the processor 202, may be configured to determine the first score associated with the user, based on the received information.

Prior to the determination of the first score, the processor 202 may be configured to parse the received information. The processor 202 may utilize one or more parsing algorithms, such as top down parsing algorithm, bottom up parsing algorithm, bottom up with top down filtering, and/or the like, for parsing the received information. Thereafter, the processor 202 may identify the first parameter and the second parameter from the parsed information. For example, a user “U₁” may transmit information, such as “a fire accident at Madison avenue at 2:00 PM.” In this scenario, the processor 202 may parse the information to identify the first parameter as “Madison avenue” and the second parameter as “fire accident.” Further, the score generation unit 208 may determine the first score associated with the parsed information.

In an embodiment, after parsing the information, the processor 202 may check whether the received information is complete or incomplete. In an embodiment, if the received information comprises the first parameter and the second parameter, the processor 202 may consider the information to be complete. In an alternate embodiment, if the received information does not comprise the first parameter and/or the second parameter, the processor 202 may consider the information to be incomplete. In a scenario, when the processor 202 determines that the information is incomplete, the processor 202 may discard the information. Further, the processor 202 may transmit a notification to the user for retransmitting the complete information.

In an embodiment, the score generation unit 208 may determine the first score for the user, based on the count of times the user transmits the information or the accuracy level of the information transmitted by the user. For example, the score generation unit 208 may determine a first score for a first user (who transmits the information “five” times a day), which is higher compared with a first score of a second user (who transmits the information “four” times a day). In another embodiment, the processor 202 may be configured to determine the accuracy level of the information. In an embodiment, the processor 202 may utilize a count of users transmitting the same information for determining the accuracy level of the information.

In an exemplary implementation, a first event occurs at a geographical location “G₁” at “2:00 PM.” The transceiver 206 receives, from “30 users,” information pertaining to the first event at “2:05 PM.” The transceiver 206 further receives, from “2” users, information pertaining to the first event (occurred at the same geographical location “G₁”) at “3:00 PM.” In such a case, based on the count of users transmitting the information pertaining to the same first event occurred at the geographical location “G₁” at “2:00 PM,” the processor 202 may determine that the information received at “2:05 PM” is more accurate compared with the information received at “3:00 PM.” Thus, the score generation unit 208 may determine a higher first score for a user, who first transmitted the information at “2:05 PM” for the first event occurred at the geographical location “G₁” at “2:00 PM.”

In another embodiment, the processor 202 may utilize a current location of the user, received from the GPS sensors of the user-computing device 102, for determining the accuracy level of the information. In an exemplary implementation, the transceiver 206 receives information, pertaining to the first event that occurred at the geographical location “G₁” at “2:00 PM,” from a first user and a second user. The processor 202 may determine the current location of the first user as “G₁,” and the current location of the second user as “G₂.” In this scenario, the processor 202 may determine that the information received from the first user may be more accurate as the current location of the first user is “G₁,” which is the same geographical location “G₁” at which the first event occurred.

In another embodiment, the processor 202 may determine an importance level associated with information. In an embodiment, the processor 202 may determine the importance level associated with the information based on a preference of events, as specified by the service provider. For example, a service provider may assign a higher preference to an even related to “fire accident,” compared with an event associated with “mob agitation.” Thus, processor 202 may determine that the importance level associated with the event “fire accident” is higher than the importance level associated with the event “mob agitation.” Thus, the score generation unit 208 may determine a first score for a user (who first transmitted the information pertaining to the event “fire accident”), which is higher compared with a first score for another user (who transmitted the information pertaining to the event “mob agitation”).

At step 406, the received information is processed. In an embodiment, the processor 202, in conjunction with the processor 202, may be configured to process the received information. In an embodiment, the processor 202 may be configured to process the received information for storing it in the hierarchal database. The processing of the received information is explained based on a sub-flowchart for step 406, as illustrated in FIG. 4B.

With reference to FIG. 4B, at sub-step 406A, a node, from a set of nodes at a level of the hierarchal database, is identified. In an embodiment, the comparator 210, in conjunction with the processor 202, may be configured to identify the node, from the set of nodes at the level of the hierarchal database. The identified node comprises a bounding box associated with the first parameter, a set of first pointer values, and the first array. The first array further comprises one or more second pointer values. In an embodiment, the processor 202 may identify the node, based on the first parameter identified from the parsed information. In an embodiment, the first parameter (e.g., “Madison avenue”) may be associated with a geographical location.

In an embodiment, prior to the identification of the node, the processor 202 may be configured to query the database server 106 to extract the geographical location record. Thereafter, the processor 202 may utilize the geographical map in the extracted geographical location record to identify coordinates associated with the first parameter. For example, the processor 202 may identify “(x₁, y₁)” as the coordinates associated with the first parameter (e.g., “Madison avenue”) of the information transmitted by a user “U₁” by utilizing the geographical map.

After the identification of the coordinates, the processor 202 may query the database server 106 to extract the hierarchal database. In an embodiment, the processor 202 may utilize a top to bottom approach for traversing the hierarchal database for the identification of the node. The processor 202 may identify a bounding box at a level in the hierarchal database that may be associated with the coordinates of the first parameter. Thereafter, the processor 202 may identify the child nodes of the node associated with the identified bounding box. In an embodiment, the processor 202 may identify the child nodes by utilizing the set of first pointer values associated with the node. Further, the processor 202 may identify a child node of the node, whose bounding box is associated with the coordinates of the first parameter. Traversing down the hierarchal database, the processor 202 may reach a leaf node, associated with the coordinates of the first parameter, at the bottom level of the hierarchal database first parameter. Thus, the leaf node may correspond to the identified node for the received information.

For example, with reference to Table 1, the processor 202 may identify the bounding box “(a₆, b₆, c₆, d₆),” associated with node “A,” that satisfies the coordinates “(x₁, y₁)” associated with the first parameter (e.g., “Madison avenue”). Further, the processor 202 may identify the child nodes (i.e., “B” and “C”) of the node “A” by utilizing the set of first pointer values of the node “A” (i.e., “[B, C]”). The processor 202 may identify that the bounding box “(a₄, b₄, c₄, d₄),” associated with the node “B,” further satisfies the coordinates “(x₁, y₁)” associated with the first parameter. Thereafter, the processor 202 may further identify the leaf node “D” (which is the child node of “B”), whose bounding box “(a₁, b₁, c₁, d₁)” encompasses the coordinates “(x₁, y₁)” associated with the first parameter. The processor 202 may identify the child node of “B” by utilizing the set of first pointer values (i.e., “[D, E]”) of the node “B.” Thus, node “D” corresponds to the identified node for the received information.

In an alternate embodiment, the processor 202 may fail to identify any leaf node, whose bounding box is associated with the first parameter. In this scenario, the processor 202 may update the hierarchal database for the insertion of a new leaf node with bounding box satisfying the first parameter. A person having ordinary skill in the art will understand that the processor 202 may utilize general hierarchal database update rules for updating the hierarchal database for the insertion of the node.

The identified node comprises the first array. The first array of the identified node further comprises the one or more pointer values. For example, with reference to Table 2, the first array (i.e., “[e₁, e₂]”) of the identified node “D” comprises two pointer values “e₁” and “e₂.”

At step 406B, the second pointer value from the one or more second pointer values is identified that is associated with the second parameter. The identified second pointer value is associated with the second array that comprises the set of entities, each entity in the set of entities having the second score. In an embodiment, the processor 202 may be configured to identify the second pointer value from the one or more second pointer values associated with the second parameter. In an embodiment, the processor 202 may utilize the second parameter in the parsed information for the identification of the second pointer value from the one or more second pointer values of the identified node. In an embodiment, the second parameter may correspond to an event that occurred at the geographical location associated with the first parameter.

For example, the processor 202 may identify a second pointer value “e₁” in the one or more second pointer values of the first array (i.e., “[e₁, e₂]”) of the identified node “D.” The second pointer value “e₁” may be identified, based on an event identifier (e.g., “fire”) associated with the second parameter (e.g., “fire accident”) in the information transmitted by the user. The comparator 210 may be configured to compare the second parameter (i.e., “fire accident”) with the event identifier (i.e., “fire”) for the identification of the second pointer value.

In an embodiment, the identified second pointer value may be associated with a second array. The second array associated with the identified second pointer value may comprise the set of entities. Each entity in the set of entities has the second score. In an embodiment, an entity in the set of entitles may comprise a user identification and the second score associated with the user associated with the entity. For example, with reference to Table 2, the processor 202 may identify the second pointer value “e1” in the first array of the identified node “D.” The identified second pointer value is associated with the second array (i.e., “[(U₂, 11), (U₃, 2), (U₇, 1)]”) comprising the set of entities (i.e., “(U₂, 11)”, “(U₃, 2),” and “(U₇, 1)”). Each entity in the second array comprises a user identification, such as “U₃” in “(U₃, 2),” of the user, who has transmitted the information and the second score, such as “2” in “(U₃, 2).”

In an alternate embodiment, the processor 202 may fail to identify the second pointer value that satisfies the second parameter of the received information. In this scenario, the processor 202 may update the first array of the identified node to insert a new second pointer value that is associated with the second parameter. A person having ordinary skill in the art will understand that the processor 202 may use general rules that are known in the art to update the first array of the identified node.

At step 406C, the received information is stored as an indexed entity in the second array, if the first score of the information is greater than or equal to the second score of at least one entity in the set of entities. In an embodiment, the processor 202, in conjunction with the comparator 210, may be configured to store the received information as the indexed entity in the second array. In an embodiment, the comparator 210 may be configured to compare the first score associated with the received information with the second score of each entity in the second array associated with the identified second pointer value. Based on the result of the comparison, the processor 202 may store the received information as the indexed entity in the second array.

In an embodiment, based on the comparison, the comparator 210 may determine that the first score of the received information is greater than or equal to the second score of at least one entity in the set of entities. Thereafter, the processor 202 may store the received information as the indexed entity in the corresponding second array. In an alternate embodiment, based on the comparison, the comparator 210 may determine that the first score of the received information is lesser than the second score of each entity in the set of entities. In this scenario, the processor 202 may check the length of the second array. If the count of the entities in the second array is less than the length of the second array, the processor 202 may store the received information as the indexed entity in the corresponding second array. Else, the processor 202 may not store the received information as the indexed entity in the hierarchal database 300a.

For example, with reference to Table 2, the comparator 210 may compare the first score (e.g., “5”) of the information, such as “a fire accident at Madison avenue at 2:00 PM,” received from a user “U₁,” with the second score of each entity in the second array of the identified second pointer value “e₁” of the identified node “D.” In this scenario, the processor 202 may determine that the first score of the received information is greater than two entities (i.e., “(U₃, 2)” and “(U₇, 1)”) in the set of entities. Therefore, the processor 202 may store the received information as the indexed entity (i.e., “(U₁, 5)”) in the set of entities, as “U₁” is the user identification of the user and “5” is the first score associated with the information. After the storage of the received information, the updated second array is “[(U₂, 11), (U₁, 5), (U₃, 2)].” Further, the processor 202 may update the second score of each of the entities in the parent node of the hierarchal database 300a, based on the update of the second array of the corresponding child node. With reference to FIG. 3B, in the updated hierarchal database 300b, the shaded second array associated with the child node “D” represents an update of the set of entities in the second array based on the received information from the user “U₁.” Further, the parent nodes (“B” and “A”) associated with the shaded second array are also updated. The updated second arrays associated with the parent nodes have also been depicted as the shaded second arrays. Table 3 illustrates the updated second array after the storage of the received information as the entity.

TABLE 3
Illustration of updated second array after the storage of information as an
indexed entity in the hierarchal database 300b.

| | | Second pointer | |
|---|---|---|---|
| Node | First array | values | Second array |
| A | [e₁, e₂] | e₁ | [(U₃, 15), (U₂, 14), (U₅, 11)] |
| | | e₂ | [(U₁, 14), (U₂, 11), (U₃, 10)] |
| B | [e₁, e₂] | e₁ | [(U₂, 11), (U₅, 6), (U₁, 5)] |
| | | e₂ | [(U₂, 6), (U₁, 4), (U₃, 3)] |
| C | [e₁, e₂] | e₁ | [(U₃, 15), (U₅, 5), (U₂, 3)] |
| | | e₂ | [(U₁, 10), (U₃, 7), (U₂, 5)] |
| D | [e₁, e₂] | e₁ | [(U₂, 11), (U₁, 5), (U₃, 2)] |
| | | e₂ | [(U₂, 5), (U₁, 4), (U₇, 1)] |
| E | [e₁, e₂] | e₁ | [(U₅, 6), (U₈, 1), (U₉, 1)] |
| | | e₂ | [(U₃, 3), (U₂, 1), (U₉, 1)] |
| F | [e₁, e₂] | e₁ | [(U₃, 15), (U₅, 5), (U₂, 3)] |
| | | e₂ | [(U₁, 10), (U₃, 7), (U₂, 5)] |

A person having ordinary skill in the art will understand that the scope of the abovementioned example is for illustrative purpose and should not be construed to limit the scope of the disclosure.

At step 406D, the control (from FIG. 4B) returns to end step 408 in FIG. 4A.

The detailed method for the information retrieval from the hierarchal database associated with the spatial region has been described later in FIG. 5.

FIG. 5 is a flowchart that illustrates a method for information retrieval for a spatial region, in accordance with at least one embodiment. FIG. 5 is described in conjunction with FIGS. 1-4B. With reference to FIG. 5, there is shown a flowchart 500 that illustrates the method for information retrieval for the spatial region. For the purpose of ongoing description, the method has been explained for one query received from a service provider. However, the scope of the disclosure should not be construed limiting to the query. In an embodiment, the following steps can also be performed for multiple queries from multiple service providers. A person having ordinary skill in the art will understand that the examples, as described below in FIG. 5, are for illustrative purpose and should not be construed to limit the scope of the disclosure. With reference to FIG. 5, the method starts at step 502 and proceeds to step 504.

At step 504, the query is received for retrieval of the processed information from a hierarchal database, such as the hierarchal database 300a or 300b. The query comprises a first entity selection criteria, a second entity selection criteria, and a count of entities. In an embodiment, the transceiver 206, in conjunction with the processor 202, may be configured to receive the query for the retrieval of the processed information from the hierarchal database. The transceiver 206 may be configured to receive the query from the agent-computing device 108 associated with the service provider. For example, the transceiver 206 may receive a query, such as “top two users in Madison Avenue that reported about a fire accident.”

After the reception of the query, the processor 202 may be configured to parse the query to extract the first entity selection criteria, the second entity selection criteria, and the count of entities from the received query. In an embodiment, the processor 202 may utilize one or more parsing algorithms, known in the art, for parsing the received query. Example of the parsing algorithms may be Top down parsing algorithm, Bottom up parsing algorithm, Bottom up with top down filtering, and/or the like. For example, the processor 202 may parse the query “top two users in Madison Avenue who reported about a fire accident” to extract the first entity selection criteria (i.e., “Madison Avenue”), the second entity selection criteria (i.e., “fire accident”), and the count of entities (i.e., “two”).

In an embodiment, the first entity selection criteria in the received query may be associated with a geographical location in the spatial region. Further, the second entity selection criteria may be associated with an event that occurred at the geographical location in the spatial region. Further, the count of entities may be associated with the users that transmitted the information pertaining to the event that occurred at the geographical location.

At step 506, the node is identified from the set of nodes at a level of the hierarchal database, wherein the node comprises at least the set of first pointer values and the first array, wherein the first array comprises the one or more second pointer values. In an embodiment, the processor 202 in conjunction with the comparator 210 may be configured to identify the node from the set of nodes at the level of the hierarchal database, wherein the node comprises at least the set of first pointer values and the first array, wherein the first array comprises the one or more second pointer values. For the identification of the node, the processor 202 may utilize the bounding box associated with each node in the set of nodes at the plurality of levels in the hierarchal database.

Prior to the identification of the node, the processor 202 may query the database server 106 for extracting the geographical location record comprising the geographical map of the spatial region. Thereafter, the processor 202 may be configured to determine the coordinates of the geographical location associated with the first entity selection criteria by utilizing the geographical map. For example, the processor 202 may determine the coordinates (i.e., (x₁, y₁)) of the geographical location associated with the first entity selection criteria, such as “Madison Avenue”, in the received query.

After the identification of the coordinates, the processor 202 may query the database server 106 to extract the hierarchal database. In an embodiment, the processor 202 may utilize the top to bottom approach for traversing the hierarchal database for the identification of the node. Further, the processor 202 may utilize the coordinates of the geographical location to identify a node at a top level in the hierarchal database that has the bounding box that encompasses the determined coordinates. In an embodiment, the comparator 210 may compare the determined coordinates with the bounding box of each node at the top level. Based on the comparison, the processor 202 may identify the bounding box that encompasses the determined coordinates. Further, the processor 202 may identify the child nodes of the node by utilizing the set of first pointer values associated with the node. Similarly, the processor 202 may further identify the child node of the node, whose bounding box is associated with the coordinates of the geographical location. Further traversing down the hierarchal database, the processor 202 may reach the final level in the hierarchal database, such that no bounding box at a level lower to the final level satisfies the determined coordinates. Thereafter, the processor 202 may be configured to identify a node at the final level, whose bounding box encompasses the coordinates. Thus, the node at the final level may correspond to the identified node for the received query.

In an exemplary implementation, with reference to Table 1, the processor 202 may identify the bounding box “(a₆, b₆, c₆, d₆),” associated with node “A,” that encompasses the coordinates “(x₁, y₁)” associated with the first entity selection criteria (e.g., “Madison Avenue”). Further, the processor 202 may identify the child nodes (i.e., “B” and “C”) of the node “A” by utilizing the set of first pointer values of the node “A” (i.e., “[B, C]”). The processor 202 may identify that the bounding box of the node “B” (i.e., (a₄, b₄, c₄, d₄)) further satisfies the coordinates “(x₁, y₁)” associated with the first entity selection criteria. Thereafter, the processor 202 may identify the node “D” (i.e., the child node of “B”) at the final level, whose bounding box further encompasses the coordinates “(x₁, y₁)” associated with the first entity selection criteria. The processor 202 may identify the child node of “B” by utilizing the set of first pointer values (i.e., “[D, E]”) of the node “B.” Thus, node “D” corresponds to the identified node for the received query.

In another exemplary implementation, the processor 202 may receive a query, such as “top two users in Manhattan that reported about a fire accident.” With reference to Table 1, the processor 202 may identify the bounding box “(a₆, b₆, c₆, d₆),” associated with node “A” at the top level, that encompasses the coordinates “(x₃, y₃)” associated with the first entity selection criteria (e.g., “Manhattan”) in the query. Further, the processor 202 may identify the child nodes (i.e., “B” and “C”) of the node “A” by utilizing the set of first pointer values of the node “A” (i.e., “[B, C]”). The processor 202 may identify that the bounding box of the node “B” (i.e., (a₄, b₄, c₄, d₄)) further satisfies the coordinates “(x₃, y₃)” associated with the first entity selection criteria. Thereafter, the processor 202 may identify that no bounding box of any node at a level lower to the level comprising node “B” satisfies the coordinates “(x₃, y₃).” Thus, the node “B” may correspond to the identified node and the level associated with the node “B” may correspond to the final level for the received query.

A person having ordinary skill in the art will understand that the abovementioned exemplary implementation is for illustrative purpose and should not be construed to limit the scope of the disclosure.

In an embodiment, the comparator 210 may be configured to perform a first comparison between the bounding box of each node and the first entity selection criteria. The first comparison may correspond to the identification of the node by comparing the coordinates of the geographical location associated with the first entity selection criteria in the query with the geographical location associated with the bounding box of the node.

At step 508, the second pointer value from the one or more second pointer values that satisfies the second entity selection criteria is identified, wherein the identified second pointer value is associated with the second array that comprises the set of entities. In an embodiment, the processor 202 may be configured to identify the second pointer value from the one or more second pointer values that satisfy the second entity selection criteria in the received query. The processor 202 may utilize the second entity selection criteria in the received query to identify the second pointer value from the one or more second pointer values. In an embodiment, the event associated with the second entity selection criteria may be associated with an event identifier. In an embodiment, the comparator 210 may be configured to compare the event identifier associated with the second entity selection criteria with the event identifier associated with each second pointer value in the first array of the identified node. In an embodiment, the comparison may correspond to the second comparison.

In an exemplary scenario, with reference to Table 3, the processor 202 may identify the second entity selection criteria, such as “fire accident”, in the received query (i.e., “top two users in Madison Avenue that reported about a fire accident”). The processor 202 may identify “fire” as the event identifier associated with the second entity selection criteria. Thereafter, the comparator 210 may compare the event identifier “fire” with the event identifier associated with each second pointer value in the first array of the identified node “D.” Based on the comparison, the processor 202 may identify a second pointer value “e₁” in the one or more second pointer values of the first array (i.e., “[e₁, e₂]”) of the identified node (i.e., “D”), such that the second pointer value “e₁” has “fire” as the event identifier.

A person having ordinary skill in the art will understand that the abovementioned exemplary scenario is for illustrative purpose and should not be construed to limit the scope of the disclosure.

In another embodiment, based on the second comparison the processor 202 may not identify any second pointer value that may satisfy the second entity selection criteria. In such a case, the transceiver 206 may transmit a notification to the agent-computing device 108 associated with the service provider. The notification may display a message, (e.g., “NO RESULTS FOUND”), to the service provider.

At step 510, the subset of entities from the set of entities is retrieved based on the count of entities in the received query as a display item. In an embodiment, the processor 202 may be configured to retrieve the subset of entities from the set of entities based on the count of entities in the received query as the display item. The processor 202 may utilize the count of entities in the received query to select the subset of entities from the set of entities. In an embodiment, the count of entities in the received query may be equal to the count of entities in the set of entities. In this scenario, the processor 202 may retrieve the set of entities as the display item.

In an exemplary scenario, the transceiver 206 may receive a query, such as “top two users in Madison Avenue that reported about a fire accident.” Based on the received query, the processor 202 may determine the count of entities as “two.” With reference to Table 3, thereafter, the processor 202 may retrieve the subset of entities (i.e., “(U₂, 11)” and “(U₁, 5)”) from the second array associated with the identified second pointer value “e₁” of the identified node “D.”

In another exemplary scenario, the transceiver 206 may receive a query, such as “top three users in Madison Avenue that reported about a fire accident.” Based on the received query, the processor 202 may determine the count of entities as “two.” With reference to Table 3, thereafter, the processor 202 may retrieve the set of entities (i.e., “(U₂, 11),” “(U₁, 5),” and “(U₃, 2)”) from the second array associated with the identified second pointer value “e₁” of the identified node “D.”

A person having ordinary skill in the art will understand that the abovementioned exemplary scenario is for illustrative purpose and should not be construed to limit the scope of the disclosure.

In an embodiment, the time taken by the processor 202 to execute the query (i.e., the response time of the query) is independent of the count of entities in the subset of entities retrieved from the hierarchal database. The response time of the query is further independent of the count of the one or more second pointer values in the first array of the identified node in the hierarchal database.

After the retrieval of the subset of entities, the transceiver 206 may be configured to transmit the subset of entities to the agent-computing device 108 associated with the service provider. In an embodiment, the subset of entities may be displayed to the service provider as the display item.

In an embodiment, the processor 202 may query the database server 106 to retrieve the user profiles of the user associated with the entities in the retrieved subset of entities. Thereafter, the processor 202 may further transmit the retrieved user profiles to the agent-computing device 108 as the display item. The GUI for displaying the retrieved subset of entities to the service provider has been described later in FIGS. 7A and 7B.

FIG. 6 is a block diagram that illustrates an exemplary Graphical User Interface (GUI) presented to a user on an exemplary user-computing device for providing information, in accordance with at least one embodiment. FIG. 6 is explained in conjunction with FIGS. 1-5.

The exemplary GUI, such as a GUI 600, may be displayed on a display screen of an exemplary user-computing device, such as the user-computing device 102, associated with a user. The user may be required to log into the online information portal (e.g., a city management service portal) by inputting his/her credentials, such as user identification (i.e., “U₁”) and password. In an embodiment, the online information portal may be associated with the service provider. The processor 202 may present the GUI 600 on the user-computing device 102, when the user has logged in.

In an embodiment, the GUI 600 may comprise an information submission window 602. The information submission window 602 may comprise a first input box 604 (for “REPORT”) that may be utilized by the user to input the information. The information submission window 602 may comprise a second input box 606 (for “LOCATION”) that may be utilized by the user to input a geographical location associated with the information. The information submission window 602 may further comprise a third input box 608, (for “EVENT”) that may be utilized by the user to input an event that occurred at the geographical location. The information submission window 602 may further comprise a fourth input box 610 (for “TIME”), that may be utilized by the user to input a time of occurrence of the event. Thereafter, the user may click on a first tab 612 to submit the information.

In an embodiment, the information submission window 602 may comprise a second tab 614, such as “VIEW USER PROFILE,” which may be utilized by the user to view/update the user profile of the user, “U₁.” In an embodiment, the user may utilize the user profile to view the information transmitted by the user “U₁” and the second score of the user “U₁” associated with the one or more events at the one or more geographical locations in the spatial region.

In an embodiment, if the user “U₁” fails to input information in one or more of the input boxes (i.e., 604, 606, 608, and 610), the information may be considered as incomplete. Thus, the user “U₁” may receive a notification from the application server 104 to transmit the complete information.

A person having ordinary skill in the art will understand that the abovementioned GUI 600 is for illustrative purposes and should not be construed to limit the scope of the disclosure.

FIG. 7A is a block diagram that illustrates a first exemplary Graphical User Interface (GUI) presented to a service provider on an exemplary agent-computing device for providing the query, in accordance with at least one embodiment. FIG. 7A is explained in conjunction with FIGS. 1-5.

The exemplary GUI, such as a GUI 700a, may be displayed on a display screen of an exemplary agent-computing device, such as the agent-computing device 108, associated with a service provider. The service provider may be required to log into the online information portal (e.g., a city management service portal) by inputting his/her credentials, such as service identification, (i.e., “S₁”) and password. The processor 202 may present the GUI 700a on the agent-computing device 108, when the service provider has logged in.

In an embodiment, the GUI 700a may comprise a query submission window 702. The query submission window 702 may comprise a first input box 704 (for “QUERY”) that may be utilized by the service provider to input the query. The query submission window 702 may comprise a second input box 706 (for “LOCATION”) that may be utilized by the service provider to input a geographical location associated with the query. The query submission window 702 may further comprise a third input box 708 (for “EVENT”) that may be utilized by the service provider to input an event that occurred at the geographical location. The query submission window 702 may further comprise a fourth input box 710 (for “TIME”) that may be utilized by the service provider to input a time of occurrence of the event. Thereafter, the service provider may click on a tab 712, such as a “SUBMIT” tab, to submit the query.

A person having ordinary skill in the art will understand that the abovementioned GUI 700a is for illustrative purposes and should not be construed to limit the scope of the disclosure.

FIG. 7B is a block diagram that illustrates a second exemplary Graphical User Interface (GUI) presented to a service provider on an exemplary agent-computing device for providing the query, in accordance with at least one embodiment. FIG. 7B is explained in conjunction with FIGS. 1-5.

The second exemplary GUI, such as a GUI 700b, may be displayed on a display screen of an exemplary agent-computing device, such as the agent-computing device 108, associated with a service provider. The service provider may be required to log into the online information portal (e.g., a city management service) by inputting his/her credentials, such as service identification and password. The processor 202 may present the GUI 700b on the agent-computing device 108, when the service provider has logged in.

In an embodiment, the GUI 700a may comprise a query submission window 702. The query submission window 702 may comprise a first input box 704 (for “QUERY”) that may be utilized by the service provider to input the query. The query submission window 702 may comprise a tab 706, such as “LOCATION” tab. The service provider may click on the “LOCATION” tab 706 to select a geographical location associated with the query. A new window 714, such as “LOCATION SELECTION” window is displayed, when the service provider clicks on the “LOCATION” tab 706. The “LOCATION SELECTION” window 714 comprises a geographical map 716 of a spatial area. In an embodiment, the application server 104 may be configured to retrieve the geographical map 716 from the geographical location record stored in the database server 106. In an embodiment, the service provider may select a single location (with coordinates as (x₁, y₁)), associated with the query, by clicking on the geographical map 716. In an alternate embodiment, the service provider may select an area, such as a rectangle 718, associated with the query on the geographical map 716. The application server 104 may be configured to extract the coordinates, such as (a₁, b₁, c₁, d₁), of the selected location or area 718 to identify the geographical location associated with the query.

The query submission window 702 may further comprise a second input box 708 (for “EVENT”) that may be utilized by the service provider to input an event that occurred at the geographical location. The query submission window 702 may further comprise a third input box 710 (for “TIME”) that may be utilized by the service provider to input time of occurrence of the event. Thereafter, the service provider may click on a tab 712, such as a “SUBMIT” tab, to submit the query. Thereafter, based on the query the service provider may be presented a result to the query on the agent-computing device 108.

A person having ordinary skill in the art will understand that the abovementioned GUI 700b is for illustrative purposes and should not be construed to limit the scope of the disclosure.

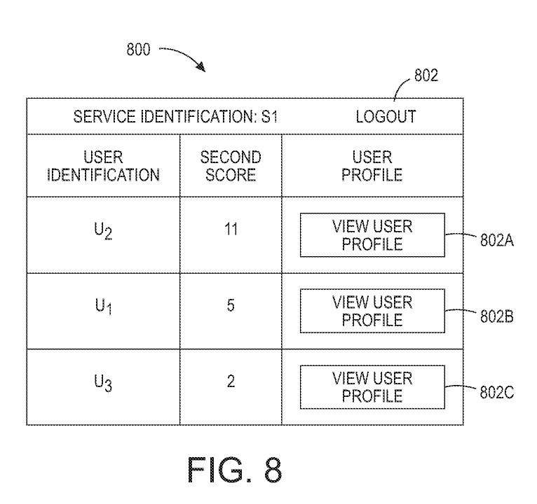

FIG. 8 is a block diagram that illustrates an exemplary Graphical User Interface (GUI) presented to a service provider on an exemplary agent-computing device for displaying a result of a query, in accordance with at least one embodiment. FIG. 8 is explained in conjunction with FIGS. 1-7.

The exemplary GUI, such as a GUI 800, may be displayed on a display screen of an exemplary agent-computing device, such as the agent-computing device 108, associated with a service provider in response to a query from the service provider.

In an embodiment, the GUI 800 may present the retrieved subset of entities as a display item 802. The display item 802 may comprise a first column “USER IDENTIFICATION” that shows user identification of the users, such as “U₁,” “U₂,” and “U₃,” associated with the retrieved subset of entities. The display item 802 may further comprise a second column “SECOND SCORE” that shows the second score associated with the user associated with the retrieved subset of entities. The display item 802 may further comprise a third column “USER PROFILE” that shows tabs 802a, 802b, and 802c that, upon clicking, enable the service provider to view the user profile of corresponding user associated with an entity in the retrieved subset of entities.

A person having ordinary skill in the art will understand that the abovementioned exemplary GUI is for illustrative purpose and should not be construed to limit the scope of the disclosure.

The disclosed embodiments encompass numerous advantages. The disclosure provides a method and a system for information processing and information retrieval for a spatial region. The disclosed methods and systems utilize a hierarchal database for structured storage of received information as an indexed entity. The hierarchal database is utilized to store information provided by users pertaining to one or more events occurring at one or more geographical locations in the spatial region. Further, the disclosed system and method dynamically update the hierarchal database, when a new information is received. The disclosed method and system utilizes the hierarchal database to extract entities (i.e., the processed information) based on a received query. The disclosed method and the system improves the performance of the system as a response time associated with the query is independent of the count of entities retrieved from the hierarchal database. Further, the response time of the query is independent of the count of one or more events in the hierarchal database. The disclosed system and method may be utilized by one or more service providers, such as city governments, town planning departments, law enforcement departments and/or the like for efficient and scalable storage and retrieval of the information gathered from one or more users on a crowd-sensing platform. The extracted entities may correspond to top “k” users that transmitted information on the crowd-sensing platform.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C,’ ‘C++,’ ‘Visual C++’ and ‘Visual Basic.’ Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix,’ ‘DOS,’ ‘Android,’ ‘Symbian,’ and ‘Linux.’

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for information processing and information retrieval for a spatial region have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of information retrieval for a spatial region, the method comprising:
receiving, by one or more transceivers in an electronic device, a query that comprises a first entity selection criteria, a second entity selection criteria, and a count of entities;
identifying, by one or more processors in the electronic device, a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values;
identifying, by the one or more processors in the electronic device, a second pointer value from the one or more second pointer values that satisfies the second entity selection criteria, wherein the identified second pointer value is associated with a second array that comprises a set of entities; and
retrieving, by the one or more processors in the electronic device, a subset of entities from the set of entities based on the count of entities in the received query, wherein a response time of the query is independent of the count of entities in the subset of entities retrieved from the hierarchal database.

2. The method of claim 1, wherein a first pointer value in the set of first pointer values is associated with a child node of a parent node, wherein the parent node corresponds to the identified node.

3. The method of claim 1, wherein the bounding box of the identified node in the set of nodes is associated with a geographical location, wherein the geographical location is associated with the spatial region.

4. The method of claim 3, wherein the second pointer value in the one or more second pointer values, of the first array in the identified node, for associated with an event occurred at the geographical location.

5. The method of claim 1, wherein an entity in the set of entities is associated with information received from a user, wherein the information comprises at least a geographical location and an event occurred at the geographical location, wherein the information is associated with a first score.

6. The method of claim 5, wherein the first score for the information is determined based at least on a number of times the user transmits the information or an accuracy level of the information.

7. The method of claim 5, wherein each entity in the set of entities is arranged in the second array based on a second score associated with each entity in the set of entities, wherein the second score is determined based on the first score of the corresponding information.

8. The method of claim 1, wherein the first array is a hash-based array, wherein the second array is a fixed-length array.

9. The method of claim 1, wherein a response time of the query is further independent of a count of the one or more second pointer values in the first array.

10. A method of information processing, the method comprising:
receiving, by one or more transceivers in an electronic device, information from another electronic device associated with a user, wherein the information comprises a first parameter, a second parameter, and a first score associated with the user;
processing, by one or more processors in the electronic device, the received information, wherein the processing of the received information comprises:
identifying, by the one or more processors in the electronic device, a node, from a set of nodes at a level of a hierarchal database, having a bounding box that is associated with the first parameter, wherein the identified node comprises a set of first pointer values and a first array, wherein the first array comprises one or more second pointer values,
identifying, by the one or more processors in the electronic device, a second pointer value from the one or more second pointer values that is associated with the second parameter, wherein the identified second pointer value is associated with a second array that comprises a set of entities, wherein each entity in the set of entities has a second score, and
storing, by the one or more processors in the electronic device, the received information as an indexed entity in the second array, if the first score of the information is greater than or equal to the second score of least one entity in the set of entities.

11. The method of claim 10, wherein the first parameter in the received information is associated with a geographical location, wherein the second parameter in the received information is associated with an event occurred at the geographical location.

12. The method of claim 10, further comprising determining, by the one or more processors in the electronic device, the first score for the received information based on one or both of: a number of times the user transmits the information and an accuracy level of the information.

13. The method of claim 10, wherein a first pointer value in the set of first pointer values is associated with a child node of a parent node, wherein the parent node corresponds to the identified node.

14. The method of claim 10, wherein the first array is a hash-based array structure in which the second pointer value from the one or more second pointer values is associated with an indexed event occurred at a geographical location.

15. The method of claim 10, wherein the second array is a fixed-length array structure that includes indexed information associated with the set of entities.

16. The method of claim 10, further comprising:
receiving, by the one or more transceivers in the electronic device, a query for retrieval of the processed information from the hierarchal database, wherein the query comprises a first entity selection criteria, a second entity selection criteria, and a count of entities, wherein the retrieval comprises a first comparison between a bounding box of a node and the first entity selection criteria and a second comparison between a second pointer value in a first array and the second entity selection criteria.

17. The method of claim 16, wherein a response time associated with the query is independent of the count of entities retrieved from the hierarchal database and a count of the one or more second pointer values in the first array.

18. The system for information retrieval for a spatial region, the system comprising:
one or more processors in an electronic device configured to:
receive a query, by utilizing one or more transceivers in the electronic device, that comprises a first entity selection criteria, a second entity selection criteria, and a count of entities;
identify a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values;
identify a second pointer value from the one or more second pointer values that satisfies the second entity selection criteria, wherein the identified second pointer value is associated with a second array that comprises a set of entities; and
retrieve a subset of entities from the set of entities based on the count of entities in the received query, wherein a response time of the query is independent of the count of entities in the subset of entities retrieved from the hierarchal database.

19. The system of information processing, the system comprises:
one or more processors in an electronic device configured to:
receive information, by utilizing one or more transceivers in the electronic device, from another electronic device associated with a user, wherein the information comprises a first parameter, a second parameter, and a first score associated with the user;
process the received information, wherein for processing the received information the one or more processors in the electronic device are configured to:
identify a node, from a set of nodes at a level of a hierarchal database, having a bounding box that is associated with the first parameter, wherein the identified node comprises a set of first pointer values and a first array, wherein the first array comprises one or more second pointer values,
identify a second pointer value from the one or more second pointer values that is associated with the second parameter, wherein the identified second pointer value is associated with a second array that comprises a set of entities, wherein each entity in the set of entities has a second score, and
store the received information as an indexed entity in the second array, if the first score of the information is greater than or equal to the second score of least one entity in the set of entities.

20. A computer program product for use with a computer, the computer program product comprising a non-transitory computer readable medium, wherein the non-transitory computer readable medium stores a computer program code for information retrieval for a spatial region, wherein the computer program code is executable by one or more processors to:
receive a query, by utilizing one or more transceivers, that comprises a first entity selection criteria, a second entity selection criteria, and a count of entities;
identify a node, from a set of nodes at a level of a hierarchal database, having a bounding box associated with the spatial region, which satisfies the first entity selection criteria, wherein the node comprises at least a set of first pointer values and a first array, wherein the first array comprises one or more second pointer values;
identify a second pointer value from the one or more second pointer values that satisfies the second entity selection criteria, wherein the identified second pointer value is associated with a second array that comprises a set of entities; and
retrieve a subset of entities from the set of entities based on the count of entities in the received query, wherein a response time of the query is independent of the count of entities in the subset of entities retrieved from the hierarchal database.

21. A computer program product for use with a computer, the computer program product comprising a non-transitory computer readable medium, wherein the non-transitory computer readable medium stores a computer program code for information processing, wherein the computer program code is executable by one or more processors to:
receive information, by utilizing one or more transceivers, from another electronic device associated with a user, wherein the information comprises a first parameter, a second parameter, and a first score associated with the user;
process the received information, wherein for processing the received information the computer program code is executable by one or more processors to:
identify a node, from a set of nodes at a level of a hierarchal database, having a bounding box that is associated with the first parameter, wherein the identified node comprises a set of first pointer values and a first array, wherein the first array comprises one or more second pointer values,
identify a second pointer value from the one or more second pointer values that is associated with the second parameter, wherein the identified second pointer value is associated with a second array that comprises a set of entities, wherein each entity in the set of entities has a second score, and
store the received information as an indexed entity in the second array, if the first score of the information is greater than or equal to the second score of at least one entity in the set of entities.
